(19) United States
(12) Patent Application Publication
(10) Pub. No.: US 2026/0285509 A1
(43) Pub. Date: Sep. 24, 2026

(54) MORPHING DRONE THROUGH SHAPE CHANGE FOR MULTIMODAL VEHICLES

(71) Applicant: VIRGINIA TECH INTELLECTUAL PROPERTIES INC., Blacksburg, VA (US)

(72) Inventors: Michael B. Bartlett, Blacksburg, VA (US); Brittan T. Wilcox, Blacksburg, VA (US)

(21) Appl. No.: 18/996,247

(22) PCT Filed: Jul. 18, 2023
(86) PCT No.: PCT/US2023/070395

§ 371 Date: Jan. 17, 2025

Related U.S. Application Data
(60) Provisional application No. 63/390,027, filed on Jul. 18, 2022.

(51) Int. Cl. B64U 10/70; B64U 10/14; B64U 50/14; B64U 50/19

(52) U.S. Cl. CPC B64U 10/70; B64U 10/14; B64U 50/14; B64U 50/19

(57) ABSTRACT

Various examples are provided related to drones or other robotic vehicles that can morph for multimodal operation. In one example, a robotic vehicle includes a chassis; rotors that can provide lift to operate the robotic vehicle in a flying mode when the rotors are positioned in a first orientation; and a rotor actuation system attached to the chassis. Individual rotors can include a rim that can provide rotational support to operate the robotic vehicle in a driving mode when the rotors are positioned in a second orientation. The rotor actuation system can switch the rotors between the first and second orientations.

### CROSS REFERENCE TO RELATED APPLICATIONS

This application claims priority to, and the benefit of, co-pending U.S. provisional application entitled “Morphing Drone Through Shape Change for Multimodal Vehicles” having Ser. No. 63/390,027, filed Jul. 18, 2022, which is hereby incorporated by reference in its entirety.

### STATEMENT REGARDING FEDERALLY SPONSORED RESEARCH OR DEVELOPMENT

This invention was made with government support under grant no. D18AP00041 awarded by the Defense Advanced Research Projects Agency and grant no. N000142112699 awarded by the Office of Naval Research. The Government has certain rights in the invention.

### BACKGROUND

Robotically controlled vehicles are used in a wide range of applications for operation in or over a variety of terrains. The ability to operate a vehicle under different conditions can be advantageous. Biological organisms are extraordinary in their ability to change physical form to perform different functions. Mimicking these capabilities in engineered systems has the potential to create multifunctional robots that adapt form and function on-demand for search and rescue, environmental monitoring, and transportation.

### SUMMARY

Aspects of the present disclosure are related to drones or other robotic vehicles that can morph for multimodal operation. In one aspect, among others, a vehicle, comprises a chassis; a plurality of rotors configured to provide lift to operate the robotic vehicle in a flying mode when the plurality of rotors are positioned in a first orientation, where individual rotors of the plurality of rotors comprise a rim configured to provide rotational support to operate the robotic vehicle in a driving mode when the plurality of rotors are positioned in a second orientation; and a rotor actuation system attached to the chassis, the rotor actuation system controllable to switch the plurality of rotors between the first and second orientations. In one or more aspects, the individual rotors can comprise a plurality of propeller blades extending radially outward from a center hub with the rim encircling the plurality of propeller blades. The rim can be formed of polycarbonate.

In various aspects, the rotor actuation system can comprise a spring tensioned actuator that rotates the plurality of rotors between the first and second orientations. The spring tensioned actuator can secure the plurality of rotors in the first orientation during the flying mode and in the second orientation during the driving mode. The spring tensioned actuator can comprise wings that support the plurality of rotors, where the wings can be rotated about corresponding rotational axis to position the plurality of rotors in the first or second orientations. Linear springs can extend between the wings, the linear springs can provide tension between the wings to maintain the plurality of rotors in the first or second orientation. The rotor actuation system can comprise a shape memory alloy (SMA) that provides an actuation force that rotates the wings to position the plurality of rotors in the first or second orientation. The SMA can simultaneously rotate the wings to reposition the plurality of rotors. Activation of the rotor actuation system can be triggered wirelessly. The rotor actuation system can reposition the plurality of rotors between the first and second orientations in about 50 msec or less.

In one or more aspects, the robotic vehicle can comprise electronic control circuitry configured to control operation of the plurality of rotors during driving and flying modes and to control operation of the rotor actuation system. The electronic control circuitry can control each of the plurality of rotors through a corresponding motor coupled to that rotor. The plurality of rotors can be controlled to rotate in a common direction during the driving mode and are controlled to rotate in multiple directions during the flying mode. The plurality of rotors can consist of four rotors with first and second rotors rotating in a first direction in the flying mode and third and fourth rotors rotating in a second direction in the flying mode. The electronic control circuitry can be configured to reverse polarity applied to motors of at least a portion of the plurality of rotors to reverse direction of rotation. The electronic control circuitry can comprise double pole, double throw (DPDT) relays that reverse connections to the motors when activated. The electronic control circuitry can comprise wireless relays configured to actuate the DPDT relays. The electronic control circuitry can comprise wireless relays configured to actuate the rotor actuation system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D illustrate an overview of an example of a latch-mediated, spring actuated driven (LaMSA-driven), multifunctional morphing robot, in accordance with various embodiments of the present disclosure.

FIGS. 2A-2E illustrate an example of a bistable LaMSA morphing system, in accordance with various embodiments of the present disclosure.

FIGS. 3A-3F illustrate an example of locomotion methodology and performance of a bistable LaMSA-driven, multifunctional morphing robot, in accordance with various embodiments of the present disclosure.

FIGS. 4A-4C illustrate effect of motor and propeller weight on shape change, in accordance with various embodiments of the present disclosure.

FIG. 5 is a schematic diagram illustrating an example of an onboard control system, in accordance with various embodiments of the present disclosure.

FIGS. 6A-6C are images illustrating testing of the bistable LaMSA-driven, multifunctional morphing robot, in accordance with various embodiments of the present disclosure.

FIGS. 7A-7C are images illustrating a thrust testing setup, in accordance with various embodiments of the present disclosure.

FIG. 8 illustrates blackbox current data conversion factor used for collection of power consumption data, in accordance with various embodiments of the present disclosure.

### DETAILED DESCRIPTION

Disclosed herein are various examples related to drones or other robotic vehicles that can morph for multimodal operation. A drone or other automated or robotic vehicle can be configured to undergo a reversible shape change to switch between a driving state and a flying state, and back again. The reversible shape change can be performed using, e.g., an actuator-spring-latch system that utilizes shape memory alloy (SMA) to provide an actuation force. Reference will now be made in detail to the description of the embodiments as illustrated in the drawings, wherein like reference numbers indicate like parts throughout the several views.

Transforming between physical states in biological organisms is energy efficient, rapid, and reversible, which provides functional diversity to achieve objectives such as traversing different terrain. These capabilities have inspired a push towards multifunctionality in engineered systems, such as various robots or machines that strive to mimic functions found in insects, birds, bats, and turtles. One promising approach to leverage such reconfigurations is shape-morphing robots, where different shapes are used to achieve different functions. The use of a shape change can help improve the performance by optimizing the form for a given task. Shape morphing can be performed in multi-modal robots using traditional motors or adaptive materials to cause a shape change for different locomotion modes. However, the morphing systems in these robots typically contrast the key aspects of biological systems, in that current engineered robots can have drawbacks such as a bulky form factor, high power usage, being tethered/connected to external power or data lines, or a long morphing duration.

One potential actuation strategy for morphing systems to overcome these challenges is using latch-mediated, spring actuated (LaMSA) systems, which have the potential to improve speed, scalability, and performance of multi-modal robots. LaMSA systems are based on the use of potential energy stored in springs and released by latch mechanisms to allow for movements with greater speed and power than traditional small scale actuation schemes. LaMSA systems are found frequently in nature, in organisms such as the mantis shrimp, trap-jaw ant, and Venus fly trap, and have led to engineered systems with amplified power output and speed.

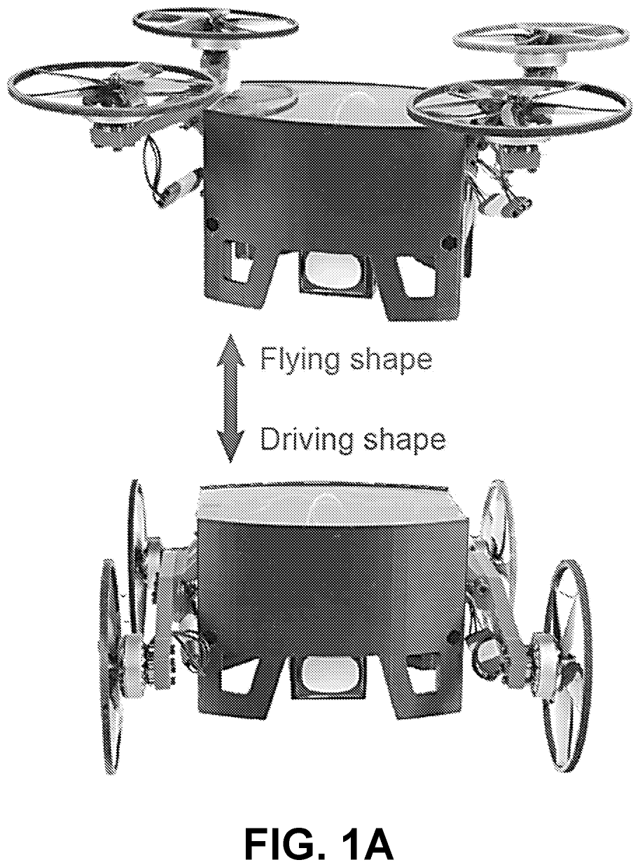

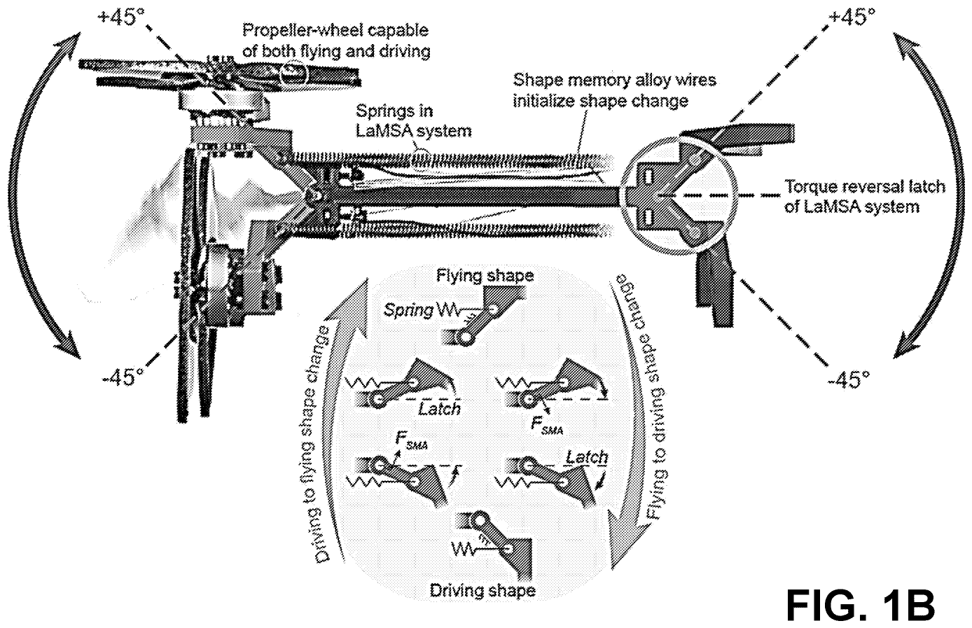

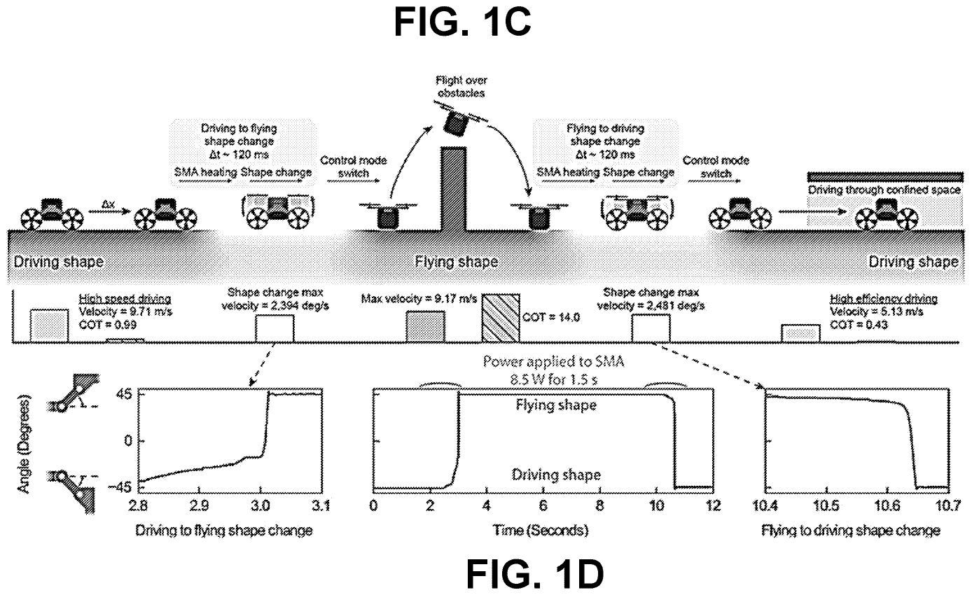

A small, reconfigurable robotic vehicle is presented that uses a LaMSA morphing system to undergo a shape change to achieve multiple locomotion modes. FIG. 1A illustrates an example of a multifunctional robot in both flying and driving shapes. Through the use of the bio-inspired LaMSA morphing system, the shape change is rapid, reversible and repeatable, so the robot can switch between its flying and driving states on-demand without external intervention. The bistable LaMSA morphing mechanism can be driven by an artificial muscle wire, which eliminates the need for traditional motors, enabling a compact and efficient system that is completely untethered during locomotion and morphing. FIG. 1B includes overlaid images showing the motion of the wing in the flying-to-driving shape change, along with an inset showing the motion and driving forces of the LaMSA shape change. The robot uses a combined propeller/wheel which enables the use of a single propulsion system for multiple locomotion modes.

This approach enables the robot to use its dual transport modes to navigate an environment which could not be readily completed by a conventional single mode robot that can only fly or drive. FIG. 1C illustrates an exemplary sequence of operations for the shape-changing robot, showing driving, flying and multiple shape changes. Through these shape changes, relevant metrics are plotted on axes below the schematic illustrations. The robot can accomplish this task while moving swiftly and efficiently through its environment with high velocities above 9 m/s (>39 body lengths per second) in both the ground and flying states, and a very low cost of transport when driving. The bottom plots of FIG. 1C illustrate velocity details for movement and transitions. In the illustrated examples, morphing between shapes takes under 50 ms with maximum angular morphing velocities above 2,300 deg/s, with only 8.5 W of power applied for 1.5 seconds total.

FIG. 1D illustrates the angle of the morphing system over time for a switch from driving to flying mode, and then a return to driving mode. The central plot of FIG. 1D shows the entire duration, while the left and right plots show just the driving-to-flying and flying-to-driving shape changes, respectively. The highlighted regions represent moments during which electric power is applied. This morphing is reversible over many cycles and power is not needed to maintain either of the two locomotion states after a morph is complete. All electronic control and power delivery systems for flying, driving and shape changing can be onboard the robot so that it operates untethered and wirelessly through remote control.

### Bistable LaMSA Morphing System

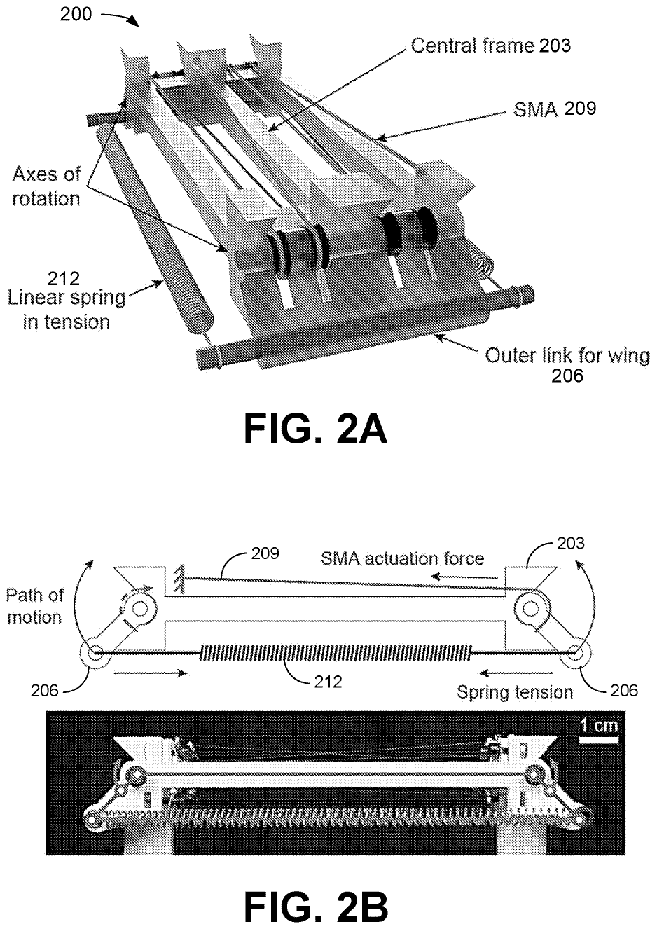

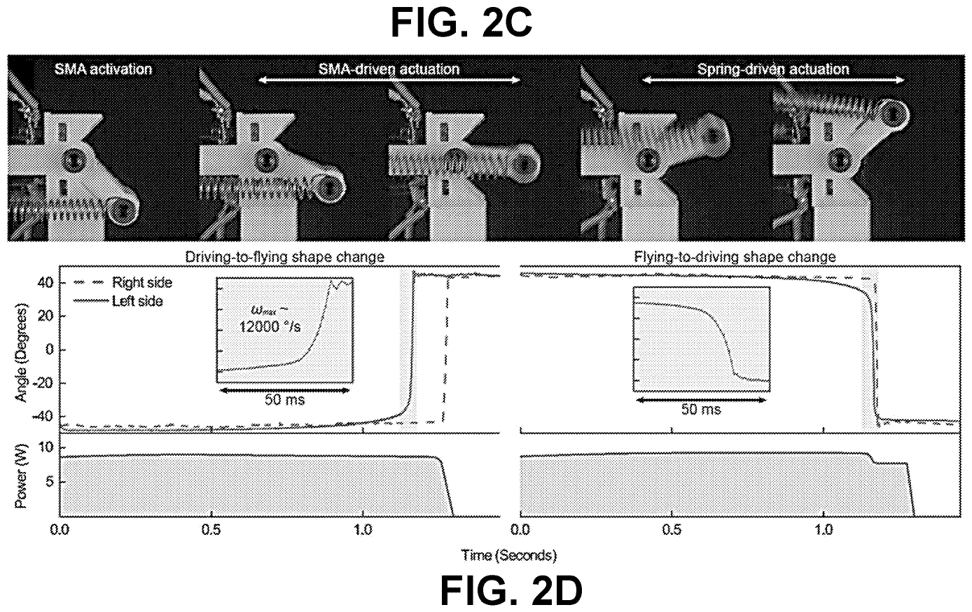

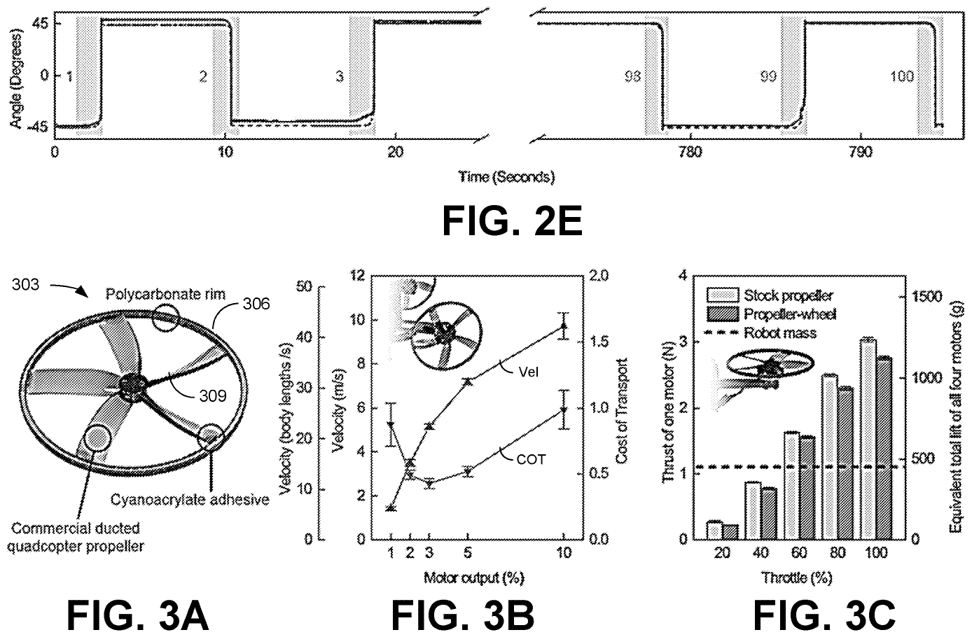

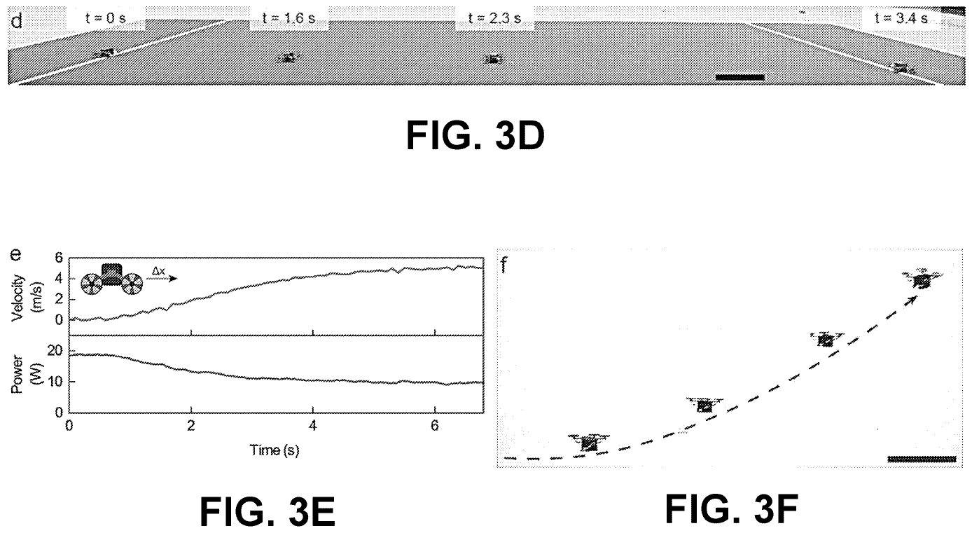

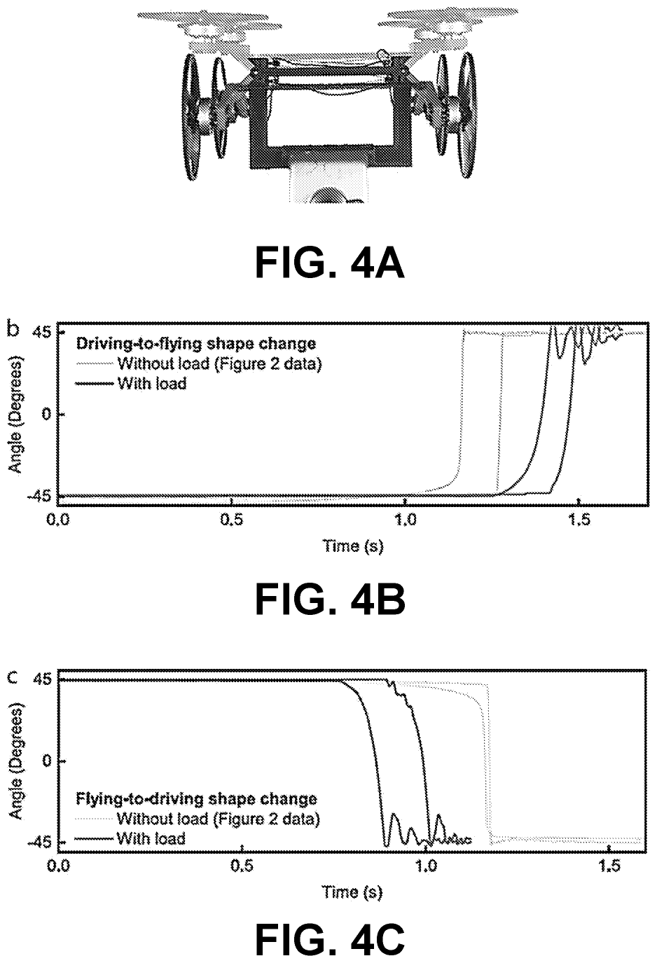

The shape change of the multifunctional robot can be performed by a LaMSA system. While LaMSA and other impulsive systems have shown amazing capabilities for robotic jumping, this extraordinary power amplification mechanism can be harnessed to controllably, reversibly, and with low power, rapidly reconfigure the robot. FIG. 2A illustrates an example of a bistable LaMSA morphing system 200. The LaMSA morphing system 200 comprises a central frame 203 with two outer wing links 206, and can be driven by shape memory alloy (SMA) artificial muscle wire 209 and linear springs 212. FIG. 2B shows a side view of the morphing system (top) with a force diagram and an image of the testing fixture (bottom). The central frame 203 rests in the body of the robot and remains fixed during a shape change. The two smaller, outer wing links 206 move throughout the shape change and are used to mount the propulsion system. This entire morphing system 200 weighs only 51 g, with the rigid frame and links fabricated through additive manufacturing. In either of its stable positions, the linear springs 212 apply a force which maintains the overall shape, such that no power is needed for the maintenance of its shape and thrust can be applied without inadvertent morphing.

To begin a shape change, two of the four SMA wires 209 are activated through the application of electric current (the other two SMA wires 209 are used for a return to the previous shape). SMA has a temperature-dependent metallic phase change, which causes the wires to shorten through Joule heating with the applied electric current. Small relative displacement and a necessary thermal cycling present unique design challenges for integration of SMA into actuation systems; however, SMA allows for compact actuation systems and has a compelling power/weight ratio at small volumes and mass. With its use in this bistable LaMSA morphing system 200, the relatively small stroke of the SMA can be transformed into a tremendous displacement. Additionally, the design of the morphing robot accommodates the necessary thermal cycling by not requiring power to maintain either functional shape. Therefore, through the use of the LaMSA mechanism, the strengths of SMA are leveraged while avoiding its drawbacks.

While the SMA wires 209 initiate the shape change, they simultaneously store energy in the springs 212; the SMA actuation moves the wing links 206 towards an unstable neutral point where the latch of the LaMSA mechanism ‘disengages’ and the stored spring energy causes a fast movement through the remainder of the motion. The point at which the force of the springs 212 switch from acting counter to the motion to powering the motion is referred to as a torque reversal latch, as the direction of the moment applied about the axis of rotation is reversed across the unstable neutral point. This rapid actuation sequence is captured with a high-speed camera and displayed in the series of images of FIG. 2C. The labels indicate which of the SMA 209 or spring 212 is applying the force powering movement, and the torque reversal latch is at the midpoint of the motion where the outer wing link 206 is horizontal.

The resultant motion of this spring actuated system is rapid, as shown in FIG. 2D. A 50 ms inset displays the rapid motion which is characteristic of a majority of the stroke. It was found that the whole shape change motion takes about 120 ms for a single wing when considering the initial build-up of SMA actuation. The latter 45° of the stroke, after the latch is released, can take as little as 5 ms. This shows that a LaMSA system can provide extremely rapid morphing, exceeding that provided by servo motors or other methods at similar scales. Additionally, power consumption for this test was measured in the range of 8-8.5 W for the short duration of the shape change, so the energy input needed by the LaMSA system was approximately 11.5 J. To show the reversibility and repeatability of the shape change mechanism, 100 cycles of the shape change were performed sequentially with an interval of 8 s. During the test, there was no loss in shape change performance (see, e.g., FIGS. 4A-4C). FIG. 2E illustrates 100 morphing cycles repeated at an interval of 8 seconds with load and release the latch many times without external intervention.

### Locomotion Methodology and Performance

The multifunctional robot uses the same motors for both flying and driving modes of transport. By using a shared propulsion system, the robot's complexity and redundancy can be reduced compared to robots which achieve multi-modality through the use of disparate systems on the same frame, or shared propulsion systems that require the addition of secondary or passive rolling hardware. A specifically designed rotor combination of a propeller and wheel can be utilized as a single structure that performs both modes of transport using the same motors, without adding extensive material or complexity to the robot. FIG. 3A Is an isometric image showing an example of a rotor 303 having a combined propeller and wheel configuration. The rotor 303 comprises a rim 306 (e.g., a polycarbonate rim or other wheel rim) which is adhered at each blade tip of a propeller 309 (e.g., a 5-blade, bullnose propeller). A bullnose propeller design was selected so that the impact on thrust-dependent aerodynamics with the addition of a wheel rim is theoretically minimized. This is because the blade tips do not need to be modified to achieve a strong connection to the outer wheel rim 306, and the aerodynamics of the original propeller 309 can be preserved.

When the multifunctional robot is in its driving shape or configuration, the rotor 303 (propeller/wheel rim) structures rotate along the ground for driving. To examine the efficiency of locomotion, the cost of transport (COT) was measured, which is given by Pᵢₙ/mgv, where Pᵢₙ is the power applied, m is the mass of the robot (450 g), g is acceleration due to gravity, and v is its velocity. From this, it was observed that 3% motor output gives the greatest efficiency with a cost of transport of 0.43, during which the robot travels at 5.13 m/s, or 22.3 body lengths/s. FIG. 3B illustrated an example of driving performance of the rotor 303 (propeller/wheel rim). The data are presented as mean values±SD (continuous measurement from the same sample over time). The inset image shows the position of the propeller 309 and wheel rim 306 in the driving shape or orientation. The fastest controlled ground speed was found to be 9.71 m/s, or 42.2 body lengths/s at 10% motor output (during the testing motor outputs greater than 10 percent were not feasible while driving). The cost of transport for this speed was still a low 0.99, which is a significant improvement over the flight cost of transport of 14.0, while achieving similar velocities. Overall, this shows excellent velocity and COT, exceeding that of other quadcopter or bio-inspired multi-modal robots, and showing similar or better performance compared to multiple specialized, single mode robots.

When the multifunctional robot is in its flying shape or configuration, the rotor (propeller/wheel rim) structure 303 is oriented such that the propeller blades generate vertical thrust upon activation of the motors. When measuring the flying thrust, the multifunctional rotor 303 (propeller/wheel rim) performs within 10% of the stock propeller at relevant motor outputs, providing sufficient lift for flight as a quadcopter drone while also enabling ground transportation. FIG. 3C illustrates measured thrust of a single rotor 303 (propeller/wheel rim), and calculated total lift for all four, compared with that of the same propeller without the added rim 306. The data are presented as mean values±SD (continuous measurement from the same sample over time). The inset image shows the position of the rotor 303 (propeller/wheel rim) in the flying shape or orientation.

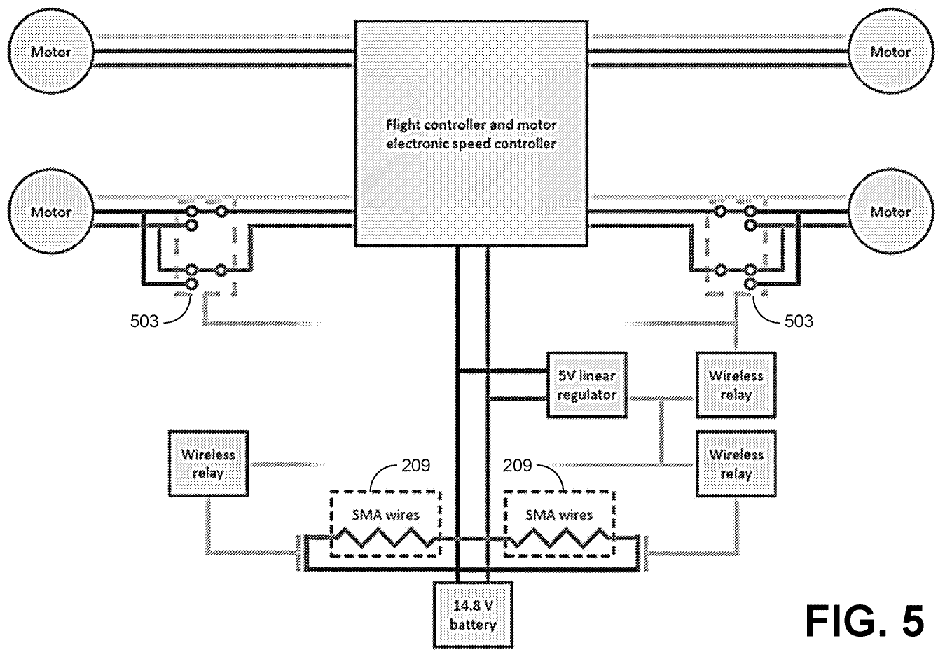

Images from the driving component of this dual locomotion capability are presented in FIG. 3D (scale bar=0.5 m), where the multifunctional robot travels across a tennis court in 3.4 seconds from a standstill. An image sequence of the multifunctional robot driving along the ground is shown at 0, 1.6, 2.3 and 3.4 seconds. This was done using 3% motor output, and the corresponding velocity and power over time are shown in FIG. 3E. The switch to driving mode utilizes a control adjustment, which can be achieved by applying an auxiliary circuit to the quadcopter drone control board as will be discussed with respect to FIG. 5.

FIG. 3F shows the image sequence of the multifunctional robot flying portion of the dual locomotion capability (scale bar=0.5 m). The top air speed of the robot was measured at 9.17 m/s. With this, the same motors were successfully utilized for both modes of transport, reducing the necessary components, controls, and complexity required to achieve flying and driving multifunctionality.

For the bistable LaMSA morphing system within the multifunctional robot, the added weight of the motors and propeller/wheels on the wing links 206 does not impede the morphing operation. An example of a test fixture with semi-opaque overlay showing both bistable positions of the wings is shown in FIG. 4A. FIGS. 4B and 4C illustrate driving-to-flying and flying-to-driving shape changes of the system, respectively, with and without motors and propellers. A small difference in the time to change was observed, wherein the driving-to-flying shape change needs slightly more time for the SMA wire actuator to heat and begin the motion, and the flying-to-driving slightly less. However, the time for the motion itself is similar at approximately 120 ms. With this rapid, reversible, repeatable, and reliable shape change, the multifunctional robot can switch between its flying and driving states on demand and stay in either shape without any power consumption.

FIG. 5 shows a block diagram and additional details regarding a supplementary control system of the multifunctional robot. A commercially available drone control board and electronic speed controller (ESC) was used alongside a compatible handheld remote controller. In this auxiliary circuit, which is powered by the same onboard battery, the SMA actuation can be triggered through wireless activation of a MOSFET-controlled circuit, and the motor direction reversal can also be triggered wirelessly. Motor direction reversal is needed in this system because, in a quadcopter drone, the propellers rotate counter to each other and are not aligned to rotate in the same direction for driving after the shape change. To align all four of the combined propeller/wheels for driving, two of the motors must rotate in the reverse direction. This direction reversal can be achieved by reversing the polarity of two motor wires using double-pole-double-throw (DPDT) relays 503 for each of the two motors. Each of these functions can be triggered by wireless relays with remote control buttons. The supplementary control system can also provide electrical power delivery for the shape change. It can be completely integrated on-board, and all functions can be wirelessly controlled.

### Multifunctional Flying and Driving Robot

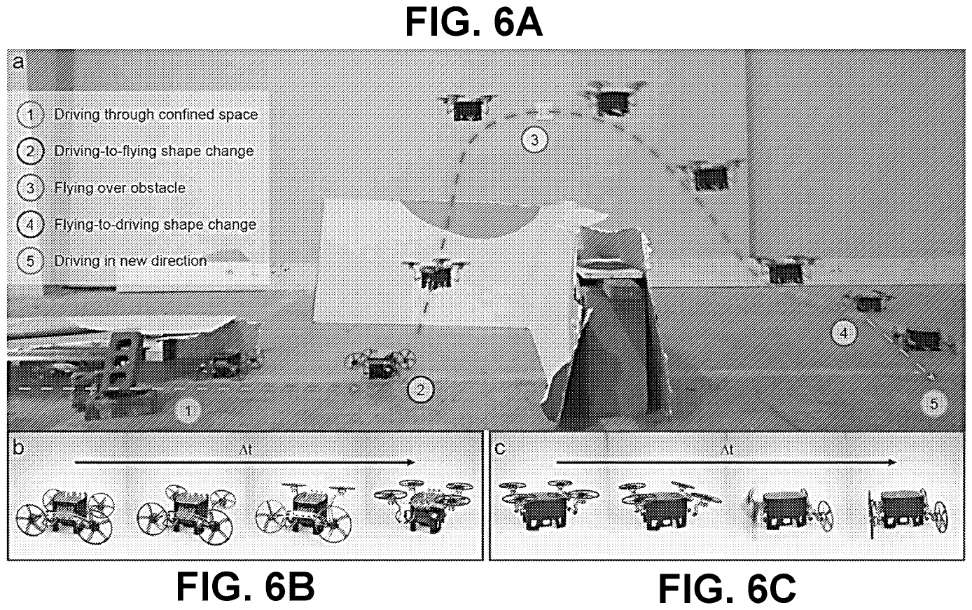

With the shape change, dual mode locomotion system, and integrated onboard electronics, the multifunctional flying and driving robot can be wirelessly controlled such that it can drive, fly, and change its shape as needed. These capabilities were demonstrated by navigating the robot through an obstacle course that would not be readily navigable by a flying or driving robot alone. This obstacle course is modeled after a destroyed building to emulate use in search and rescue, in which irregular and confined spaces may be present. FIGS. 6A-6C illustrate the use of the multifunctional flying and driving robot.

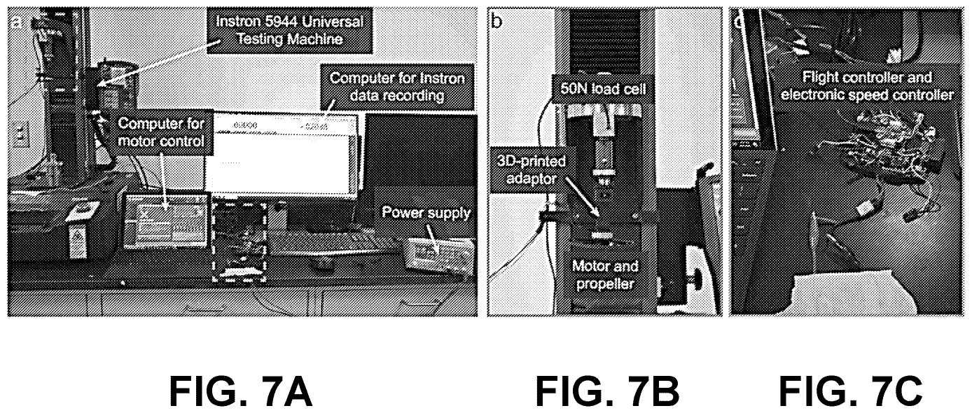

In FIG. 7A, the path of the robot through the obstacle course is shown, with the driving portions (1 and 5), flying portions (3), and morphing transitions (2 and 4) indicated. The driving portion includes a narrow tunnel, after which a wall restricts further ground movement, requiring a morphing transition and then the use of its flying function. After landing, the robot morphs again and drives away. During its endeavor, the robot changes shape twice to continue on the designed path.

In FIG. 6B, an image sequence of the robot transforming from its driving shape to flying shape is shown. The force exerted by the SMA wire 209 (FIGS. 2A-2B) on the wings 206 (FIGS. 2A-2B) is enough to overcome the initial friction between the rims 306 (FIG. 3A) and the ground. The ability to switch to flying is useful for overcoming large obstacles, reaching elevated regions, or bypassing unnavigable terrain, such as the low wall in the demonstration course.

FIG. 6C shows an image sequence of the flying-to-driving shape change of the robot. The ability to switch to driving is useful for travelling through confined spaces (such as the narrow tunnel in the demonstration course) and traversing long distances with less power than flying. During this change, the spring actuation is powerful enough to lift the entire body of the robot off the ground, giving it sufficient clearance to drive. This is enabled by the power amplification of the LaMSA system, as the power output of the springs 212 (FIGS. 2A-2B) exceeds that which can be achieved through the SMA wire actuators at this scale. This enables unique capabilities, compactness, and efficiency to be achieved compared to previous examples of multimodal or morphing robotic systems. The ability to change shape allows the robot to adapt better to its surroundings, giving it the ability to travel over more varied terrain than a single locomotion mode. All of these functions can be performed by remote control, and it does not require any manual manipulation to fly, drive, and morph as shown.

### Construction and Testing

This disclosure has shown how using a LaMSA system in a multifunctional robot represents an opportunity to utilize rapid, bio-inspired movements as components in an overall robotic design. Prior works have asserted that LaMSA systems are only competitively useful at miniature scales, as traditional actuation strategies such as motors provide better power per weight or volume for larger devices. Here, it has been demonstrated how integration of small-scale LaMSA systems into larger devices can be a powerful enabler to improve functionality and performance. By enabling multiple modes of transportation with this morphing technique, a multifunctional robot which can travel in complex environments has been demonstrated, as well as operated in an untethered and remote manner. These robotic vehicle capabilities can facilitate travel across diverse terrains. For example, a single robot can traverse a tight space at elevation by flying then driving, or a robot can traverse long distances by driving while still retaining energy to complete a flight mission, all while the operator remains a safe distance away. By considering LaMSA systems as enablers of multifunctionality or enhancements of existing systems rather than exclusively designing robots around LaMSA as the driver of a robot's primary functionality, new opportunities in advanced robots can be opened in which LaMSA principles can be applied to a greater range of robotic designs, sizes, and functionality.

Various aspects of the construction and testing of the multifunctional robots will now be discussed.

Fabrication of rigid components. Custom rigid components for the multifunctional robot were fabricated through fused filament additive manufacturing. A Raise3D Pro2 with PLA filament and PVA dissolvable supports was used to create custom components. The PVA supports were dissolved in warm tap water.

Assembly of bistable LaMSA morphing system. The rigid links of the bistable LaMSA morphing system were connected at the hinges with M3 bolts, with small 3D-printed pulleys placed in each gap for the SMA wires 209 (Flexinol MuscleWire, 250 μm diameter). Flexinol Self-Crimps were affixed to the SMA wire at a distance of 200 mm apart, and are mounted to the linkage using M2 bolts and nuts, which can be adjusted to the exact length needed for operation. The end loops of the springs (McMaster part number 5108N123) were connected to M3 bolts in locations as shown in FIG. 2A.

Fabrication of customized propellers. A circle of inner diameter 75 mm and outer diameter 80 mm was cut from a sheet of polycarbonate (McMaster part number 87225K21) with a Universal Laser Systems VLS4.75 laser cutter. This was adhered to the propeller (HQprop Duct-T75MMX5) at the edges using a cyanoacrylate adhesive (Loctite 406).

High speed actuation measurement. Movement of the bistable morphing system was measured through high speed video recording and motion tracking software. A Chronos CR21-HD high speed camera was used to record the bistable LaMSA morphing system at up to 1000 frames per second. The actuation was triggered by a Keithley 2461 Sourcemeter, set to apply 1.05 A for 1.3 seconds. An LED was set up in parallel with the morphing system and placed within the shot of the high speed camera such that the duration for which current was applied was apparent in the video. The angle of the wing linkage was measured using the video motion tracking software Physlets Tracker. For the many successive shape changes data, the Keithley was set up to automatically repeat the pulse every 8 seconds for 100 times, and a double-pole, double-throw switch was added to control which pair of SMA wires was powered. This switch was flipped manually between every instance of power application.

Propeller thrust measurement. The thrust of the propeller, as shown in FIG. 3C, was measured using an Instron 5944 universal testing system. The test was performed with a 50 N load cell. A custom-made 3D-printed fixture attached a motor and propeller to the load cell, so that generated thrust caused a pulling force on the load cell. The motor was controlled using the motor testing tool of Betaflight Configurator to control the motor output amount. This testing setup is shown in the images of FIGS. 7A-7C. FIG. 7A is an image showing the overall test setup, FIG. 7B is an image of the motor and propeller attached to the load cell using the custom fixture, and FIG. 7C is an image of the controller.

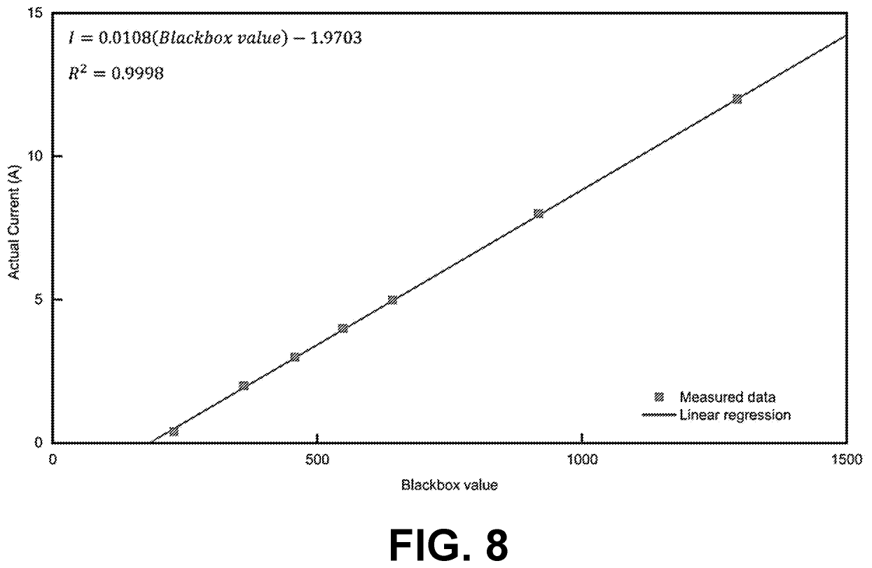

Speed measurement. The speed of the drone for both driving and flying was measured with a GPS speed meter (SkyRC GSM-015). For driving, the tests were conducted across a set of tennis courts. For flying, the tests were conducted at the Virginia Tech Drone Park (https://ictas.vt.edu/Facilities/ictasdrone-park.html). The power consumption data was collected using the blackbox feature available on the flight controller with Betaflight and Betaflight Blackbox Configurator with a conversion factor shown in FIG. 8. In FIG. 8, I is the applied current in amperes, and the Blackbox value is the unitless numerical data recorded by the blackbox flight logger. The “Actual Current” was measured using a set current limit on a controlled power supply in place of the battery.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A robotic vehicle, comprising:
a chassis;
a plurality of rotors configured to provide lift to operate the robotic vehicle in a flying mode when the plurality of rotors are positioned in a first orientation, where individual rotors of the plurality of rotors comprise a rim configured to provide rotational support to operate the robotic vehicle in a driving mode when the plurality of rotors are positioned in a second orientation; and
a rotor actuation system attached to the chassis, the rotor actuation system controllable to switch the plurality of rotors between the first and second orientations.

2. The robotic vehicle of claim 1, wherein the individual rotors comprise a plurality of propeller blades extending radially outward from a center hub with the rim encircling the plurality of propeller blades.

3. The robotic vehicle of claim 2, wherein the rim is formed of polycarbonate.

4. The robotic vehicle of claim 1, wherein the rotor actuation system comprises a spring tensioned actuator that rotates the plurality of rotors between the first and second orientations.

5. The robotic vehicle of claim 4, wherein the spring tensioned actuator secures the plurality of rotors in the first orientation during the flying mode and in the second orientation during the driving mode.

6. The robotic vehicle of claim 4, wherein the spring tensioned actuator comprises wings that support the plurality of rotors, where the wings are rotated about corresponding rotational axis to position the plurality of rotors in the first or second orientations.

7. The robotic vehicle of claim 6, wherein linear springs extend between the wings, the linear springs providing tension between the wings to maintain the plurality of rotors in the first or second orientation.

8. The robotic vehicle of claim 4, wherein the rotor actuation system comprises a shape memory alloy (SMA) that provides an actuation force that rotates the wings to position the plurality of rotors in the first or second orientation.

9. The robotic vehicle of claim 8, wherein the SMA simultaneously rotates the wings to reposition the plurality of rotors.

10. The robotic vehicle of claim 8, wherein activation of the rotor actuation system is triggered wirelessly.

11. The robotic vehicle of claim 4, wherein the rotor actuation system repositions the plurality of rotors between the first and second orientations in about 50 msec or less.

12. The robotic vehicle of claim 1, comprising electronic control circuitry configured to control operation of the plurality of rotors during driving and flying modes and to control operation of the rotor actuation system.

13. The robotic vehicle of claim 12, wherein the electronic control circuitry controls each of the plurality of rotors through a corresponding motor coupled to that rotor.

14. The robotic vehicle of claim 12, wherein the plurality of rotors are controlled to rotate in a common direction during the driving mode and are controlled to rotate in multiple directions during the flying mode.

15. The robotic vehicle of claim 14, wherein the plurality of rotors consist of four rotors with first and second rotors rotating in a first direction in the flying mode and third and fourth rotors rotating in a second direction in the flying mode.

16. The robotic vehicle of claim 14, wherein the electronic control circuitry is configured to reverse polarity applied to motors of at least a portion of the plurality of rotors to reverse direction of rotation.

17. The robotic vehicle of claim 16, wherein the electronic control circuitry comprises double pole, double throw (DPDT) relays that reverse connections to the motors when activated.

18. The robotic vehicle of claim 17, wherein the electronic control circuitry comprises wireless relays configured to actuate the DPDT relays.
